(19) United States
(12) Patent Application Publication
(10) Pub. No.: US 2020/0229641 A1
(43) Pub. Date: Jul. 23, 2020

(54) Steam Temperature Regulated Barbecue Smoking Device

(71) Applicant: Smokestack BBQ LLC, Silver Spring, MD (US)

(72) Inventors: Joseph W. Schmitz, Silver Spring, MD (US); Esther E. Kwon, Potomac Falls, VA (US)

(73) Assignee: Smokestack BBQ LLC, Silver Spring, MD (US)

(21) Appl. No.: 16/749,522

(22) Filed: Jan. 22, 2020

Related U.S. Application Data
(60) Provisional application No. 62/795,113, filed on Jan. 22, 2019.

(51) Int. Cl. A47J 37/07

(52) U.S. Cl. CPC A47J 37/0704; A47J 37/0786

(57) ABSTRACT

A steam temperature regulator and auxiliary cook basket for barbeque smoking and a barbeque including the steam temperature regulator and auxiliary cook basket are disclosed. The steam temperature regulator comprises a liquid reservoir, wherein the liquid reservoir provides a liquid barrier between a heat source and a cooking chamber, a channel through the liquid reservoir, wherein the channel provides a path for heat and/or smoke to enter the cooking chamber, and a damper positioned within the channel to adjust the amount of heat and/or smoke allowed to enter the cooking chamber. The auxiliary cook basket utilizes exhausting heat/smoke to cook and flavor small items.

### REFERENCE TO RELATED APPLICATIONS

This application claims priority to U.S. Provisional Application No. 62/795,113, filed Jan. 22, 2019, entitled “STEAM TEMPERATURE REGULATED BARBECUE SMOKING DEVICE,” and hereby specifically and entirely incorporated by reference.

### BACKGROUND

### 1. Field of the Invention

This invention is directed to methods and devices for barbecue (BBQ) smoking.

### 2. Description of the Background

Grilling and barbecue smoking are American pastimes. These cooking activities are usually performed outdoors and have historically involved wood, coal and fire to produce heat and smoky flavors in meats or vegetables. While both grilling and barbecue require a vigilant eye over a hot and smoky device, the latter has historically demanded more attention to monitor and manage a variety of temperatures including heat sources, cook chambers, flames, internal meat temperatures and more. With the introduction of gas, grills and again to lesser extent smokers, the industry continues to capitalize on more than 75% of U.S. adults who own a grill or smoker.

However, the transition to gas is discouraging to purists and often relegates true wood smoked BBQ to commercial establishments. While 75% of Americans have grilling devices, a minority own smokers. Smokers have not, in a pure (wood burning) form, been able to progress such than the “Average Joe” is willing or able to tackle a task of maintaining a fire and separately a cook temperature for hours on end.

A smoker is an apparatus for cooking, usually at low temperatures in a controlled, smoky environment. A smoker is often used for making barbecue. There are a lot of different kinds and types of smokers, from small electric units to large smoker rigs big enough to fit a whole animal. Smokers can be powered by a wide variety of fuels, including: electricity, propane or natural gas, wood, charcoal, and pellets. The traditional smokers burn wood to create both heat and smoke to cook and flavor food. Electric smokers need to have wood added to a heated chamber to produce smoke.

Barbecue of the past required precisely monitoring a “firebox”: a device for holding and burning wood to produce heat and smoke. In an uncontrolled environment, a firebox can range in temperatures from ambient outside temperatures to newly igniting wood starting at 212 degrees F. After ignition it takes a short period of time for water molecules to burn off and the wood to quickly jump to a range of temperatures from 550 degrees F. to more than 1000 degrees F., depending on the species of wood burning. By manually (or with new motorized HVAC technology) controlling air flow through the fire box, a “Pittmaster” (or user of the smoker) will typically hover around the device, manually opening and closing dampers constantly to maintain a desired temperature and burn rate. Then, based on each smoker's unique heat loss characteristics, the Pittmaster also manipulates the smoker to maintain a separate, and much more important secondary temperature in the cooking chamber of the device for the food being cooked.

While each chef may have a preference, traditional barbecue is slow cooked at a temperature of about 225 degrees F. Maintaining this temperature is intended to allow the meat being cooked (typically fattier and tougher cuts of meat are used in barbecue) to go through collagen breakdown temperatures (approximately 160-165 degrees) for the longest period of time as the temperature of the meat gradually approaches 225 degrees F. (if the meat is cooked at 225 degrees F., the meat will approach but never equal 225 degrees F.). Collagen breakdown is when fatty tissue in tougher cuts of meat transforms from chewy and unappealing to a buttery pervasiveness throughout the meat and an overall “melt-in-your-mouth” texture. Between room temperature and 225, the meat temperature will rise on a convex curve where the relationship of 225 gives the longest period of time to the meat while the meat has an internal temperature between 150-170, thus allowing for the most collagen breakdown creating the perfect umami texture.

Maintaining temperature throughout a cook, with minimal or no variance, is what allows the meat to transform to the “fall-off-the-bone” texture desired in ribs, or the same tenderness of a brisket, which seems so unattainable with any other cook method. It is also what affords the most renowned barbecue masters consistency in their end products.

Therefore, there is a need for a device which alleviates the smoker user of the many questions of temperature variations described above, the manners in which the user can choose to manage those temperatures and their relationships. Furthermore, there is a need for a device that automatically controls and maintains the cook chamber temperature to the 225(+) degrees F. range, which Pittmasters pursue to hold for hours (even days) on end, without variation.

### SUMMARY OF THE INVENTION

The present invention overcomes the problems and disadvantages associated with current strategies and designs and provides new devices and methods of barbecue cooking.

One embodiment of the invention is directed to a steam temperature regulator for barbeque smoking. The steam temperature regulator comprises a liquid reservoir, wherein the liquid reservoir provides a liquid barrier between a heat source and a cooking chamber, a channel through the water reservoir, wherein the channel provides a path for heat and/or smoke to enter the cooking chamber, and a damper positioned within the channel to adjust the amount of heat and/or smoke allowed to enter the cooking chamber.

Preferably the steam temperature regulator further comprises a liquid inlet and a liquid outlet. Preferably, the liquid outlet is positioned at a high-water point within the liquid reservoir and the outlet is positioned to allow the liquid reservoir to drain. In a preferred embodiment the steam temperature regulator further comprises a flue cap, wherein the flue cap is positionable to create a seal between the heat source and the cooking chamber. Preferably the steam temperature regulator further comprises a bypass exhaust, wherein bypass exhaust is adjustable to regulate the heat source and/or redirect smoke away from the cook chamber. The bypass exhaust is preferably adjustable by a damper.

Preferably the steam temperature regulator further comprises a flange extending from the liquid reservoir, wherein the flange provides a support to the steam temperature regulator for placement on a firebox. Preferably the steam temperature regulator further comprises a cooking surface adapted to be placed above the liquid reservoir. The steam temperature regulator is preferably adapted to be used in an existing grill.

Another embodiment of the invention is directed to a barbeque smoker. The barbeque smoker comprises a firebox, a cooking chamber, and a steam temperature regulator. The steam temperature regulator comprises: a liquid reservoir, wherein the liquid reservoir provides a liquid barrier between the firebox and the cooking chamber, a channel through the water reservoir, wherein the channel provides a path for heat and/or smoke from the fire box to enter the cooking chamber, and a damper positioned within the channel to adjust the amount of heat and/or smoke allowed to enter the cooking chamber.

Preferably the steam temperature regulator further comprises a liquid inlet and a liquid outlet. In a preferred embodiment, the outlet is positioned at a high-water point within the liquid reservoir and the liquid outlet valve is positioned to allow the water reservoir to drain. Preferably the steam temperature regulator further comprises a flue cap, wherein the flue cap is positionable to create a seal between the firebox and the cooking chamber. Preferably the steam temperature regulator further comprises a bypass exhaust, wherein bypass exhaust is adjustable to regulate a heat source within the firebox and/or redirect smoke away from the cook chamber. The bypass exhaust is preferably adjustable by a damper.

In a preferred embodiment, the steam temperature regulator further comprises a flange extending from the liquid reservoir, wherein the flange provides a support to the steam temperature regulator for placement on the firebox. Preferably the steam temperature regulator further comprises a cooking surface adapted to be placed above the water reservoir. Preferably, the barbeque smoker is a kettle grill.

Another embodiment of the invention is directed to an auxiliary cooking receptacle system for a smoker or grill. The system preferably comprises an exhaust pipe couplable to the smoker or grill, and a cooking receptacle configured to be placed into and removable from the exhaust pipe without opening the smoker or grill.

In a preferred embodiment, the cooking receptacle is a wire basket. Preferably, the exhaust pipe is coupled to a lid of the smoker or grill. Preferably, the exhaust pipe is integrated into the lid of the smoker or grill. The exhaust pipe is preferably adapted to be attached to the lid of an existing smoker or grill. Preferably, the exhaust pipe is coupled to a bypass exhaust of the smoker or grill.

Other embodiments and advantages of the invention are set forth in part in the description, which follows, and in part, may be obvious from this description, or may be learned from the practice of the invention.

### DESCRIPTION OF THE FIGURES

FIG. 1: Plan view of an embodiment of a steam temperature regulator (STR) for barbecue smoking.

FIG. 2: A sectional view of the embodiment of the STR of FIG. 1.

FIG. 3: A second sectional view of the embodiment of the STR of FIG. 1.

FIG. 4: A sectional view (similar to FIGS. 2-3), demonstrating the positioning of the STR of FIG. 1 within a kettle-style grill, including extended exhaust pipe and auxiliary cooking receptacle.

FIGS. 5A-B: Views of a second embodiment of a stem temperature regulator (STR).

### DESCRIPTION OF THE INVENTION

As embodied and broadly described herein, the disclosures herein provide detailed embodiments of the invention. However, the disclosed embodiments are merely exemplary of the invention that may be embodied in various and alternative forms. Therefore, there is no intent that specific structural and functional details should be limiting, but rather the intention is that they provide a basis for the claims and as a representative basis for teaching one skilled in the art to variously employ the present invention.

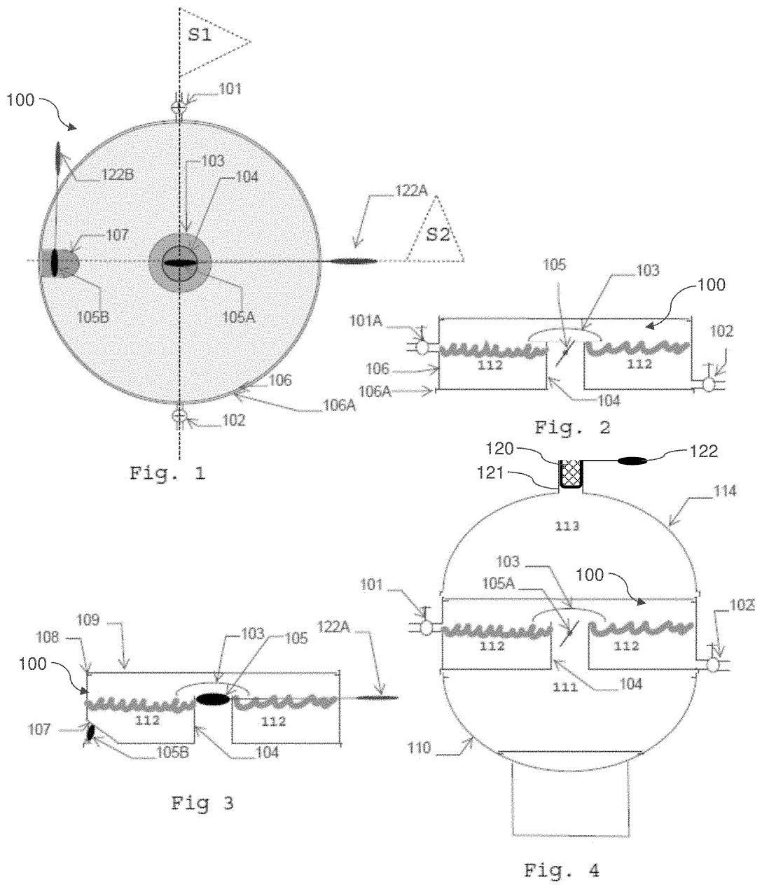

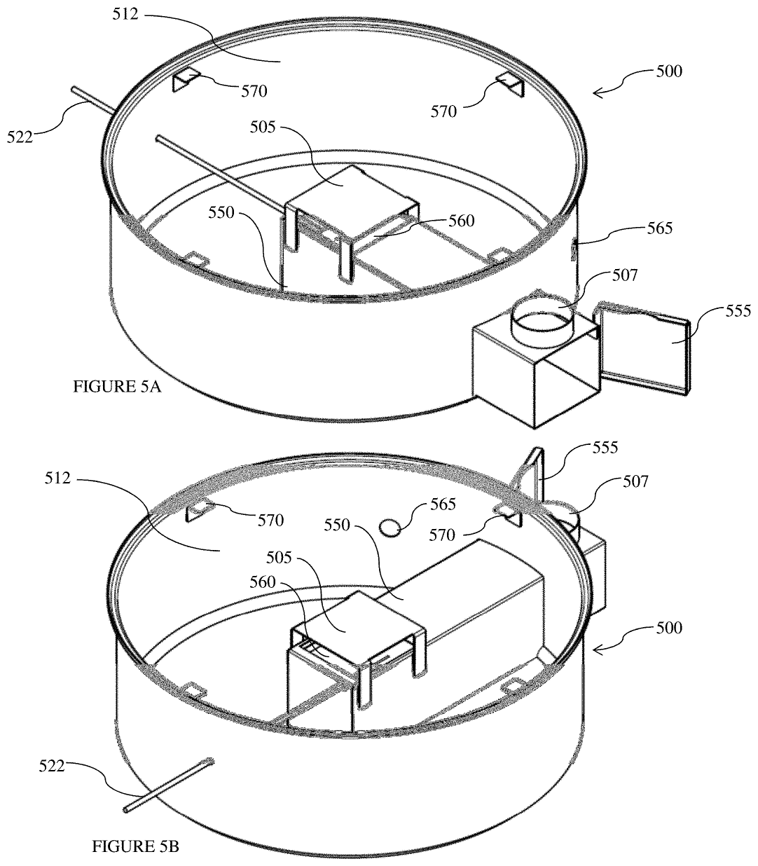

FIGS. 1-4 depict a first embodiment of a cooking/smoking steam temperature regulator (STR) 100. STR 100 may be a component of a larger grill/smoker or an aftermarket accessory to an existing grill/smoker 113. STR 100 may come in various sizes to fit existing grills/smokers 113 or may have an adapter to fit existing grills/smokers 113. Preferably, STR 100 is positioned between a heat source and a cooking chamber. For example, as shown in FIG. 4, STR 100 is positioned between combustion chamber (or firebox) 110 and cooking chamber 114. Preferably, the heat source is a combustible material able to produce sufficient heat and smoke to cook and flavor food to a desired doneness. While the invention is described with regard to smoking food, the device can be used in smokeless applications. The combustible material may be wood, charcoal, briquettes, pellets, or other burnable substances. In other embodiments, the heat source may be gas or electric heat sources with or without smoke. Preferably, the food to be cook is positioned on a surface 109 (such as a grate, griddle, or stone) or hung within cooking chamber 114. The food may be animal or plant derived. Preferably, STR 100 is able to maintain the temperature within cooking chamber 114 to between 212 degrees F. and 300 degrees F., 325 degrees F., 340 degrees F., or higher. However, depending on the food, the temperature range may increase, but preferably does not exceed 350 degrees F.

FIG. 1 shows a top or “plan view” looking down at the main portion of the steam temperature regulator (STR) 100. The body of STR 100 is water reservoir 112. While the term water is used herein, reservoir 112 may contain any liquid. Preferably the liquid is safe for consumption. For example, the liquid may be water, alcohol, broth, juice, oil, carbonated beverages, flavored liquids, or combinations thereof. Additionally, spices, herbs, or other flavorings may be added to the liquid. Preferably water reservoir 112 is placed on top of the firebox 110 or heat source and preferably creates a seal between STR 100 and firebox 110. The seal may be air tight. The seal may or may not allow pressure to build within the firebox 110. It is noted that often existing methods for smoking food include adding a pan or other receptacle of water to the heat source. In such instances, the water pan merely adds steam to the heat and does not provide a barrier between the heat source and the food. STR 100 preferably has a valved water inlet 101 and a valved water outlet 102 to fill and drain water reservoir 112. In some embodiments, the valved water inlet 101 may have an auto-fill feature such that as the water level decreases due to the liquid boiling off, the liquid will be automatically refilled. As can be seen in FIG. 2, preferably water inlet 101 is positioned at a high-water point to allow water reservoir 112 to fill and water outlet 102 is positioned at a low water point to allow water reservoir 112 to drain. In other embodiment there is a single valve to both fill and empty STR 100.

STR 100 preferably has two damper control handles 122A and 122B. Damper control handles 122A and 122B are preferably manipulated by the device operator to increase flow or restrict flow of air through one of two available flow paths. In other embodiments, mechanical or electrical devices are used instead of manual handles. Preferably, damper control handle 122A opens and closes damper 105A and damper control handle 122B opens and closes damper 105B. Preferably, damper 105A is placed within pipe 104. Pipe 104 preferably allows or restricts air (heat/smoke) to pass vertically through water reservoir 112. Damper 105A preferably controls the amount of heat and smoke that flows through pipe 104. The diameter of pipe 104 may depend on the size of water reservoir 112. Pipe 104 may be 2″ in diameter, 3″ in diameter, 4″ in diameter, 5″ in diameter, have a smaller or larger diameter, or an intermediary diameter. Pipe 104 may also have a different cross-sectional shape, for example, pipe 104 may be ovular, square, rectangular, triangular, or another shape. Preferably damper 105A is sized and shaped to completely seal pipe 104 when damper 105A is in the closed position. In some embodiments, damper 105A may be removable or positionable such that direct access between the heat source and the food may be possible. For example, when damper 105A is removed, SRT 100 may be able to be used for grilling food directly over the heat source.

Additionally, STR 100 may have a flue cap 103. Flue cap 103 is preferably operable in an up and down direction, such that the outer circumference, when lowered, is below the high point of water, thus creating a complete air/gas/smoke seal between firebox 110 and cook chamber 114. The seal may or may not allow pressure to build within the cook chamber 114. Flue cap 103 may be operable via control handle 112A or another device. Preferably, water reservoir (besides pipe 104) creates a full barrier between a combustion chamber/firebox 110 (see FIG. 4) and cooking chamber 114 (see FIG. 4). In other embodiments, STR 100 can be used in an open-air cooking environment. By providing a water barrier between firebox 110 and cooking chamber 114, preferably, the heat from the combustion source (which ranges from 212 degrees F. to over 1100 degrees F.) is used to raise the temperature of the water to 212 degrees F. (or the boiling point of water at sea level). However, depending on the elevation and the liquid within STR 100, different boiling points may be achieved. Preferably, once the water starts to boil, the temperature of the water, and, thus, the cooking chamber 114 cannot continue to increase. If a user desires to raise the temperature within cooking chamber 114 above 212 degrees F., the user can adjust damper 105A and/or flue cap 103 to allow additional heat (as well as smoke) into cooking chamber 114.

Water reservoir 112 is preferably cylindrical in shape with a sidewall 106 and a bottom 116. Preferably water reservoir 112 is open at the top. While water reservoir 112 is depicted as cylindrical, it may have another shape to fit different shaped grills or smokers. For example, water reservoir may be rectangular or an elliptic cylinder. Preferably, sidewall 106 has a flange 106A extending from a lower portion of sidewall 106 which allows STR 100 to fit on top of a firebox 110 with a close to air tight seal. In other embodiments, firebox 110 may have a ledge or lip for STR 100 to sit on. Preferably, sidewall 106 has a flange or tabs 108 extending from an upper portion of sidewall 106 to support cooking surface 109.

STR 100 may also have a smoke/heat bypass exhaust 107 controlled by damper 105B. Bypass exhaust 107 preferably allows a user to funnel smoke and heat away from cook chamber 114, and, in turn, away from the user when it is time to harvest the cooked food. Bypass exhaust 107 may be used to control the heat source. STR 100 may further include one or more flue extensions 121 to carry smoke above a level where it can interact with average height humans (or other special considerations). A flue extension 121 may be coupled to the lid of the grill (as shown in FIG. 4) or to bypass exhaust 107. STR 100 may have one or more fuel access points. For example, STR 100 may have a shoot to add more wood, coal, or other fuel source.

STR 100 may also include a flue basket cooker 120 with or without a handle 122. The flue basket cooker 120 may be a metal mesh basket designed to fit into the flue extension 121 such that food items can be placed into the smoker without opening the top. This will allow for quick steaming/smoking of items like hot dogs or shrimp without interrupting the cook chamber temperature during the cooking of larger items which may require hours of cook time.

FIGS. 5A-B depict views of a second embodiment of an STR 500. STR 500 is similar to STR 100 and elements of one may be used in the other STR. The function of STR 100 is similar to the function of STR 100 and the description of one is applicable to the other STR.

STR 500 is preferably comprised of a liquid reservoir 512 that is positionable above a heat source and below a cooking chamber. Preferably, liquid reservoir 512 is filled and/or emptied via port 565. Tabs 570 preferably support the cook surface aboce liquid reservoir 512,

Within reservoir 512 is preferably a channel 550. Preferably, channel 550 is open to the heat source below liquid reservoir 512. Channel 550 preferably allows for fuel to be added to the heat source via access door 555. Additionally, channel 550 preferably allows smoke and/or heat to flow into the cooking chamber via opening 560. Opening 560 is preferably openable and closeable via damper 505, which may be controlled by handle 522. By moving damper 505, a user is preferably able to control the amount of smoke and/or heat that enters the cooking chamber. Excess smoke that does not enter the cooking chamber is preferably exhausted via exhaust 507.

Other embodiments and uses of the invention will be apparent to those skilled in the art from consideration of the specification and practice of the invention disclosed herein. All references cited herein, including all publications, U.S. and foreign patents and patent applications, are specifically and entirely incorporated by reference. It is intended that the specification and examples be considered exemplary only with the true scope and spirit of the invention indicated by the following claims. Furthermore, the term “comprising of” includes the terms “consisting of” and “consisting essentially of.”

1. A steam temperature regulator for barbeque smoking, comprising:
a liquid reservoir, wherein the liquid reservoir provides a liquid barrier between a heat source and a cooking chamber;
a channel through the liquid reservoir, wherein the channel provides a path for heat and/or smoke to enter the cooking chamber; and
a damper positioned within the channel to adjust the amount of heat and/or smoke allowed to enter the cooking chamber.

2. The steam temperature regulator of claim 1, further comprising at least one of a liquid inlet and a water outlet.

3. The steam temperature regulator of claim 2, wherein the liquid outlet is positioned at a high-water point within the liquid reservoir.

4. The steam temperature regulator of claim 2, wherein the liquid outlet is positioned to allow the liquid reservoir to drain.

5. The steam temperature regulator of claim 1, further comprising a flue cap, wherein the flue cap is positionable to create a seal between the heat source and the cooking chamber.

6. The steam temperature regulator of claim 1, further comprising a bypass exhaust, wherein bypass exhaust is adjustable to regulate the heat source and/or redirect smoke away from the cook chamber.

7. The steam temperature regulator of claim 6, wherein the bypass exhaust is adjustable by a damper.

8. The steam temperature regulator of claim 1, further comprising a flange extending from the liquid reservoir, wherein the flange provides a support to the steam temperature regulator for placement on a firebox.

9. The steam temperature regulator of claim 1, further comprising a cooking surface adapted to be placed above the liquid reservoir.

10. The steam temperature regulator of claim 1, wherein the steam temperature regulator is adapted to be used in an existing grill.

11. A barbeque smoker, comprising:
a firebox;
a cooking chamber; and
a steam temperature regulator, wherein the steam temperature regulator comprises:
a liquid reservoir, wherein the liquid reservoir provides a liquid barrier between the firebox and the cooking chamber;
a channel through the liquid reservoir, wherein the channel provides a path for heat and/or smoke from the fire box to enter the cooking chamber; and
a damper positioned within the channel to adjust the amount of heat and/or smoke allowed to enter the cooking chamber.

12. The barbeque smoker of claim 11, the steam temperature regulator further comprising a liquid inlet and a liquid outlet.

13. The barbeque smoker of claim 12, wherein the outlet is positioned at a high-water point within the liquid reservoir.

14. The barbeque smoker of claim 12, wherein the liquid outlet is positioned to allow the liquid reservoir to drain.

15. The barbeque smoker of claim 11, the steam temperature regulator further comprising a flue cap, wherein the flue cap is positionable to create a seal between the firebox and the cooking chamber.

16. The barbeque smoker of claim 11, the steam temperature regulator further comprising a bypass exhaust, wherein bypass exhaust is adjustable to regulate a heat source within the firebox and/or redirect smoke away from the cook chamber.

17. The barbeque smoker of claim 16, wherein the bypass exhaust is adjustable by a damper.

18. The barbeque smoker of claim 11, the steam temperature regulator further comprising a flange extending from the liquid reservoir, wherein the flange provides a support to the steam temperature regulator for placement on the firebox.

19. The barbeque smoker regulator of claim 11, the steam temperature regulator further comprising a cooking surface adapted to be placed above the liquid reservoir.

20. The barbeque smoker of claim 11, wherein the barbeque smoker is a kettle grill.
